(19) United States
(12) Patent Application Publication
(10) Pub. No.: US 2008/0270938 A1
(43) Pub. Date: Oct. 30, 2008

(54) System for self-registering visitor information with geographic specificity and searchable fields

(76) Inventor: Elizabeth Marie Carlson, Chicago, IL (US)

Correspondence Address: ICE MILLER LLP, SUITE 3500, 200 WEST MADISON STREET, CHICAGO, IL, 60606, US

(21) Appl. No.: 12/150,587

(22) Filed: Apr. 29, 2008

Related U.S. Application Data
(60) Provisional application No. 60/926,938, filed on Apr. 29, 2007.

(51) Int. Cl. G06F 3/048

(52) U.S. Cl. 715/810

(57) ABSTRACT

An interactive visitor self-registration system for visitors to museums or other public sites using a digital computer or internet appliance device and a touchscreen monitor, which accesses a dedicated website, through a global computer network such as the Internet. It focuses on gathering information regarding residence of visitors as well as the information gathered by a traditional paper guest book. The system is searchable by visitors and by site staff. The information gathered by the system is stored on a dedicated website. A second, administration website, also password protected with an unpublished web address can be used by Site Administrators to customize the looks and options of their specific visitor self-registration system. Additionally, there is a public website which is accessible via the Internet which stores travel information for every signer to the system who logs on with his or her email address. These visitors can track their own travel via a map displayed on the website and be linked to the website for the sites they visit.

This application claims priority to U.S. Provisional Application No. 60/926,938, filed Apr. 29, 2007, herein incorporated by reference.

### BACKGROUND OF THE INVENTION

Museums and public sites already routinely record basic demographic information which they gather from visitors at the ticket office upon entering a site. Ticket purchasers may be asked their zip code or, in some cases, location of residence, the sale of the ticket also records age ranges of visitors based on the types of tickets purchased, and certainly the total number of visitors is recorded. In addition, many sites also have paper guest books where they ask visitors to record addresses, impressions of the site and other basic information.

Conventional paper guest book registration systems have many disadvantages. For example, paper guest books must be read page by page to glean demographic information. It is inconvenient to copy and transfer paper guest books between sites for the purpose of sharing demographic visitor information. The information is recorded by hand in ink or pencil and may not be legible or readable. The process of entering information is tedious and may discourage visitors from participating in registration. Paper guest books are bulky and require storage space. In addition, the use of paper is environmentally undesirable.

This invention improves the existing system because it is both visitor driven and site driven. It records the basic demographic information as a ticket office does, but it also enables the visitor to interact with the information gathering system as they can with a written guest book. Additionally, unlike the existing systems, it is searchable by both the site staff and the visitor.

The visitor self-registration system utilizes a searchable electronic database. Visitors have two ways to search the data base: (1) while they are at a subscriber site they can use the visitor self-registration system kiosk to enter their own information, once done, they have the option to search the system for information about and comments made by previous visitors. And (2), once back home, visitors who have included their email address in their sign in information can log onto the public website and access their own travel information which will include website links to all the sites where they signed onto the system.

The visitor self-registration system may also adapted to link sites to each other for purposes of sharing demographic visitor information. Sites in the same geographic area could know when a large group from a particular place was headed their way. Agencies that administer sites would be able to compile demographic data from different types of sites. By arranging the system so that only the non-personal information is available to multiple sites, visitor privacy would be protected while general information about traffic patterns and demographics is recorded for future use.

The present embodiment relates to a visitor self-registration system for recording and retrieving visitor registration information and, in particular, to a visitor self-registration system run on a digital computer utilizing a geographically specific process and a searchable, web-based database. The system will enable site visitors to digitally record information that would normally be entered by hand in a paper guest book. The system will record this information using touch screen technology well known to those skilled in the art, and/or standard keyboard data entry methods. The system is geography based. Each entry begins by recording, in a unique manner, the geographic identity of the visitor.

### SUMMARY OF THE INVENTION

This stand-alone computer kiosk has a touch screen. Visitors to a site may register their visit on the computer. There is a welcome screen explaining the process. If the visitor is interested, after reading the welcome screen, he or she will touch the screen to indicate his or her country of origin and continue the registration process. By touching a specific region, the visitor can select to sign in as a visitor from that place. Once the visitor touches an area of the world, a second level of specificity would be shown with a more detailed map of the region that was touched. Visitors can then touch a particular country. The system would record that information, search its map database and let the visitor know how many visitors from that country have already visited the site. Visitors who touch the United States would have a third level of specificity enabling them to register from a particular state. Once the home location, either country or state, has been displayed, the visitor will be prompted to use a keyboard to register their name, age group, number of people in their party, email address, and any comments they might want to make. The system will have already recorded the date of visit and the country or state that was selected in the first operation. Future visitors can look up who has visited from their place of origin. Visitors will also have the option of leaving a message for a site staff member.

For security reason, this would be a self-contained system, password protected, not accessible from the internet or any other mainframe system without approval from the site. Visitors would be told that their information is readable by other visitors to the site and by staff but not by the outside world in any way. Confidential information such as email addresses and age groups would only be available to site staff, and would not be searchable. This invention gives visitors a chance not only to record their name, impressions of the site, plans for a coming trip or memories of a trip which has already taken place, but to view those of others. Visitors are sometimes hesitant to page through a written guest book, but will more readily search for information on other visitors in this format. For those traveling in groups, brief messages can be left and retrieved using the comment portion of this system. Visitors are also prompted that they may send a brief message to a staff member if they have a question or comment.

Demographic information will be so much easier to retrieve from this computer system than from the standard guest book. When applying for grants or writing press releases, the site staff can retrieve data that includes not only numbers of people and dates of visits but also locations and special comments. Having all of this information recorded in a computer format will facilitate codifying visitors so they can be better served in the future. While this date is often recorded in a paper guest book, this invention has the environmental advantage of using no paper, additionally, information recorded on a digital computer database is easier to retrieve. In the case where a visitor chooses to enter his or her email address, the site will be able to compile an email mailing list for future events that might be of interest to that visitor, and perhaps to increase their membership by asking a recent visitor if he or she would be interested in becoming a member of the site.

This system also has the potential to link sites to each other, this would be especially useful during peak tourist seasons, Sites in the same geographic area could know when a large group from a particular place was headed their way. Agencies that administer sites would be able to compile demographic data from different types of sites. By making only the non-personal information available to multiple sites, visitor privacy would be protected while general information about traffic patterns is recorded for future use.

In one embodiment the system for self-registering visitor information comprises a method for registration of information in a database, comprising the steps of: providing a first database for recording information, a touchscreen display; displaying on the touchscreen display a first level geographic map that depicts a plurality of geographic locations; selecting a first geographic location from the plurality of geographic locations depicted on the first level geographic map by touching the area of the touchscreen display displaying the first geographic location; providing a second database comprising at least one second level geographic map that depicts a plurality of geographic locations, each second level geographic map corresponding to a geographic location depicted on the first level geographic map; displaying on the touchscreen display the second level geographic map that corresponds to the first geographic location; selecting a second geographic location from the plurality of geographic locations depicted on the second level geographic map displayed on the touchscreen display by touching the area of the touchscreen display displaying the second geographic location; and recording the second geographic location in the first database.

In a another embodiment, the system for self-registering visitor information comprises an apparatus for registration of information in a database, the apparatus comprising: a storage device for storing a database, a display for displaying a geographic map that depicts a plurality of geographic locations, the display in communication with the storage device, and an input device for selecting an area of the display. One of the plurality of geographic locations is recorded in the database when the area of the display displaying the geographic location is selected by the input device. In a further embodiment, a computer may be connected to the computer network remotely from the input device for accessing the information recorded in the database.

### BRIEF DESCRIPTION OF THE DRAWINGS

A fuller understanding of the present invention would become apparent from the following detailed description taken in conjunction with the accompanying drawing which forms a part of the specification and in which:

FIG. 1 is a flowchart diagram of the process steps of a visitor self-registration system.

FIG. 2 is a continued flowchart diagram of the process steps of the visitor self-registration system of FIG. 1.

FIG. 3 is a continued flowchart diagram of the process steps of the visitor self-registration system of FIGS. 1-2.

FIG. 4 is a continued flowchart diagram of the process steps of the visitor self-registration system of FIGS. 1-3.

FIG. 5 is a continued flowchart diagram of the process steps of the visitor self-registration system of FIGS. 1-4.

FIG. 6 is a continued flowchart diagram of the process steps of the visitor self-registration system of FIGS. 1-5.

FIG. 7 is a continued flowchart diagram of the process steps of the visitor self-registration system of FIGS. 1-6.

FIG. 8 illustrates a screen display embodying the opening screen of the visitor self-registration system of FIG. 1.

FIG. 9 illustrates a screen display embodying the screen of step 100 of the visitor self-registration system of FIG. 2.

FIG. 10 illustrates a screen display embodying the screen of step 250 of the visitor self-registration system of FIG. 5.

FIG. 11 illustrates a screen display embodying the screen of step 320 of the visitor self-registration system of FIG. 6.

FIG. 12 is a flowchart diagram of the process steps of an alternative embodiment of a visitor self-registration system.

FIG. 13 is a continued flowchart diagram of the process steps of the visitor self-registration system of FIG. 12.

FIG. 14 is a continued flowchart diagram of the process steps of the visitor self-registration system of FIGS. 12-13.

FIG. 15 is a continued flowchart diagram of the process steps of the visitor self-registration system of FIGS. 12-14.

FIG. 16 is a continued flowchart diagram of the process steps of the visitor self-registration system of FIGS. 12-15.

FIG. 17 is a continued flowchart diagram of the process steps of the visitor self-registration system of FIGS. 12-16.

FIG. 18 is a flowchart diagram of the process steps of the administrative component of an alternative embodiment of a visitor self-registration system.

FIG. 19 is a continued flowchart diagram of the process steps of the visitor self-registration system of FIG. 18.

FIG. 20 is a continued flowchart diagram of the process steps of the visitor self-registration system of FIGS. 18-19.

FIG. 21 is a continued flowchart diagram of the process steps of the visitor self-registration system of FIGS. 18-20.

FIG. 22 is a flowchart diagram of the process steps of the public component of an alternative embodiment of a visitor self-registration system.

FIG. 23 is a continued flowchart diagram of the process steps of the visitor self-registration system of FIG. 22.

FIG. 24 illustrates a screen display embodying the screen of step 1010 of the visitor self-registration system of FIG. 12.

FIG. 25 illustrates a screen display embodying the screen of step 1040 of the visitor self-registration system of FIG. 12.

FIG. 26 illustrates a screen display embodying the screen of step 1130 of the visitor self-registration system of FIG. 14.

FIG. 27 illustrates a screen display embodying the screen of step 1140 of the visitor self-registration system of FIG. 14.

FIG. 28 illustrates a screen display embodying the screen of step 1180 of the visitor self-registration system of FIG. 15.

FIG. 29 illustrates a screen display embodying the screen of step 1240 of the visitor self-registration system of FIG. 16.

FIG. 30 illustrates a screen display embodying the screen of step 1260 of the visitor self-registration system of FIG. 16.

FIG. 31 illustrates a screen display embodying the screen of step 1280 of the visitor self-registration system of FIG. 16.

FIG. 32 illustrates a screen display embodying the screen of step 1290 of the visitor self-registration system of FIG. 17.

FIG. 33 illustrates a screen display embodying the screen of step 1310 of the visitor self-registration system of FIG. 17.

### DETAILED DESCRIPTION OF THE INVENTION

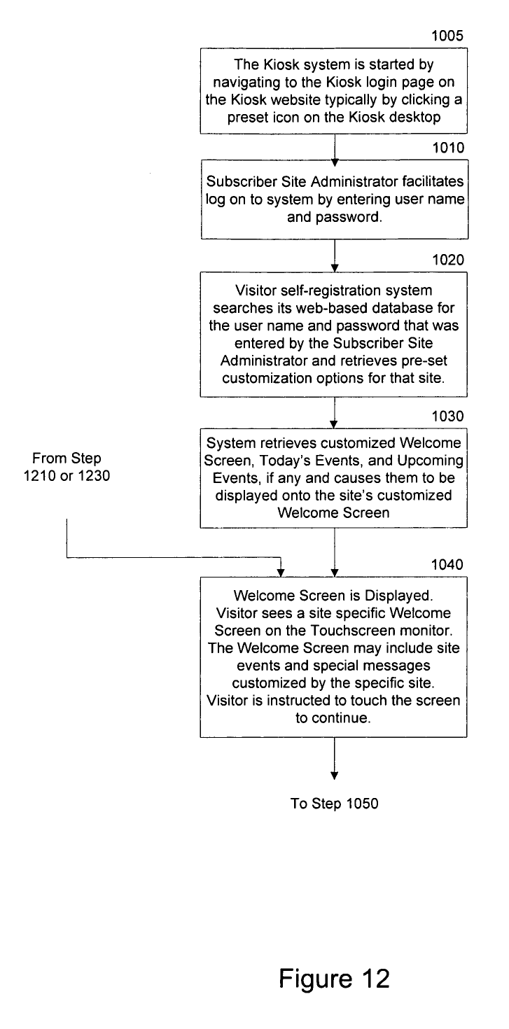

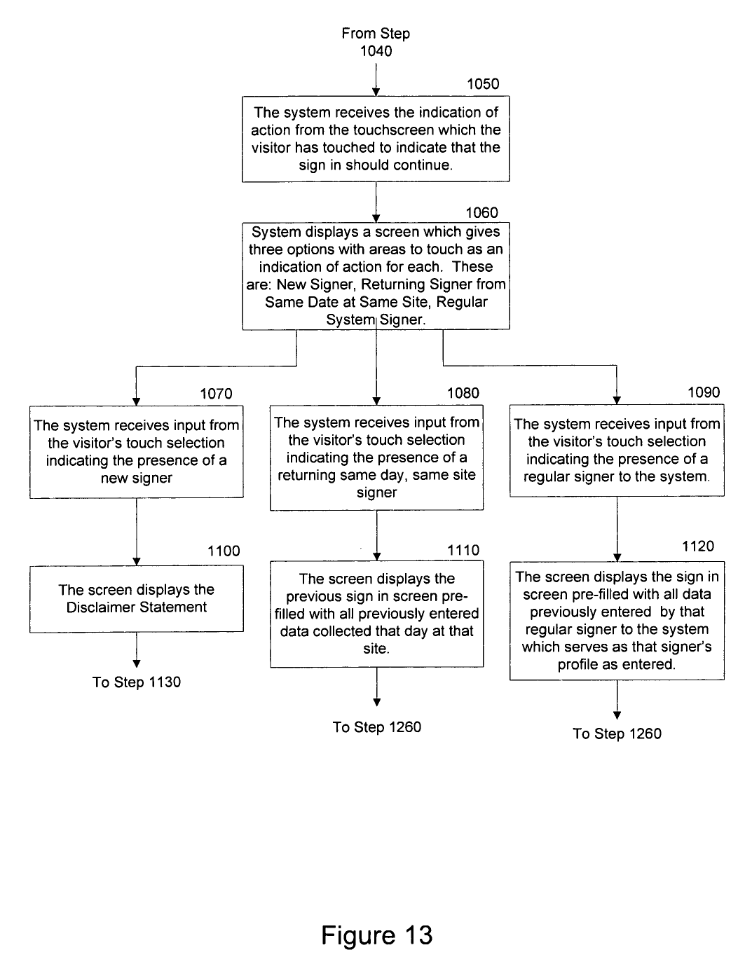

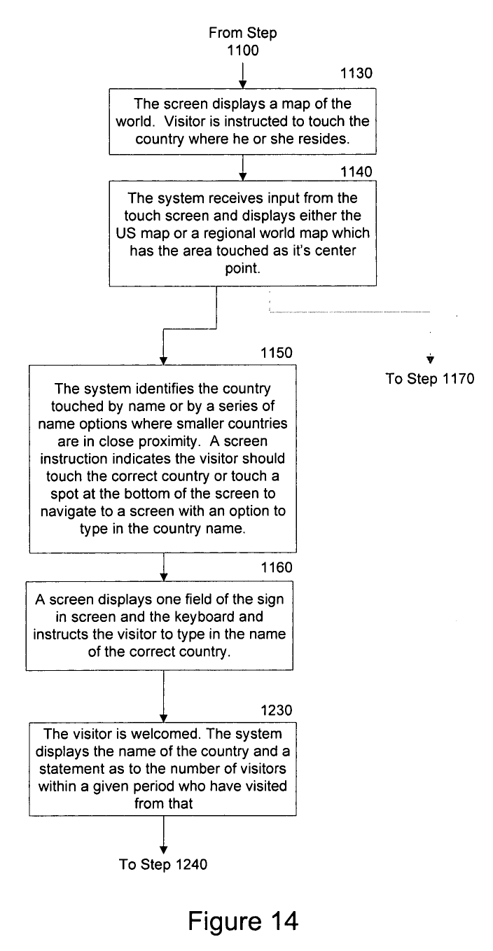

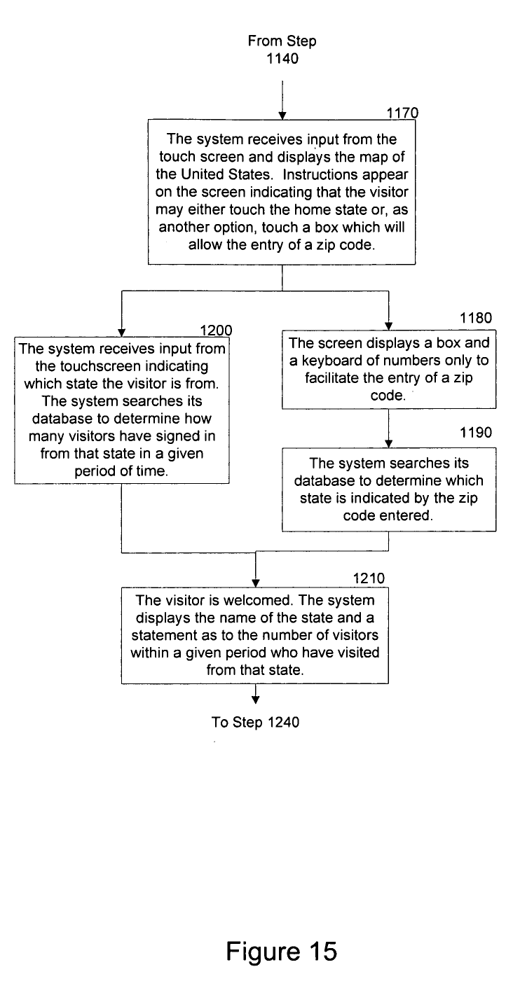

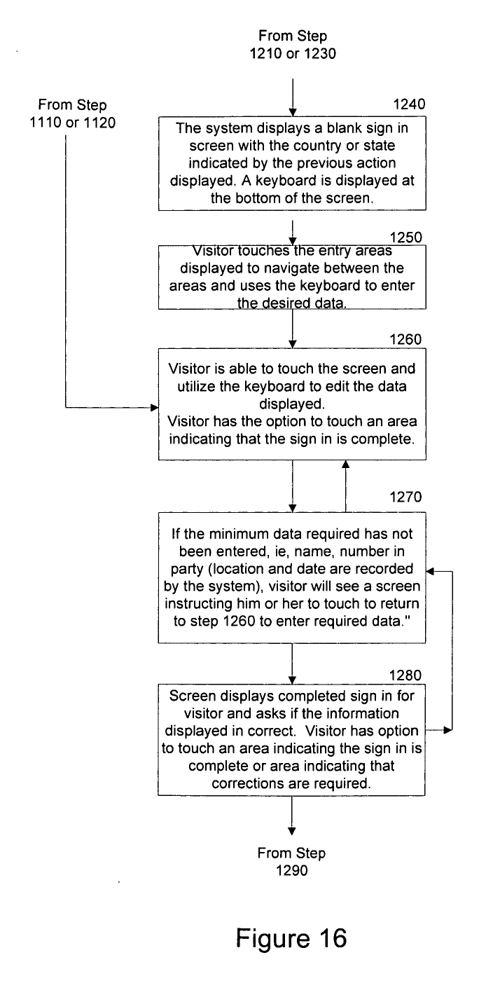

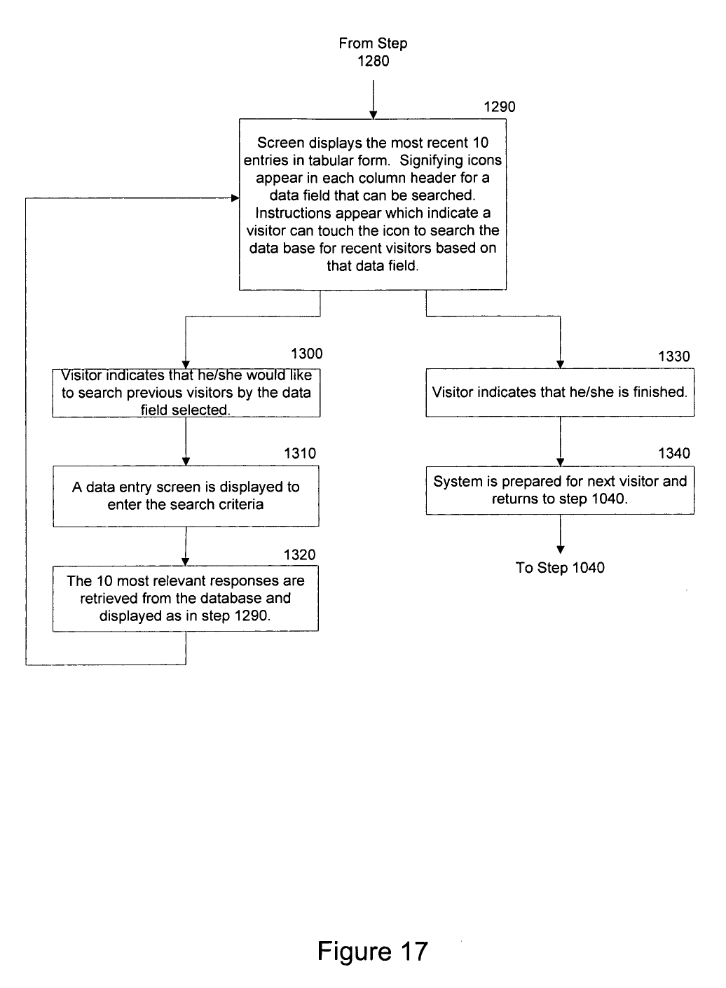

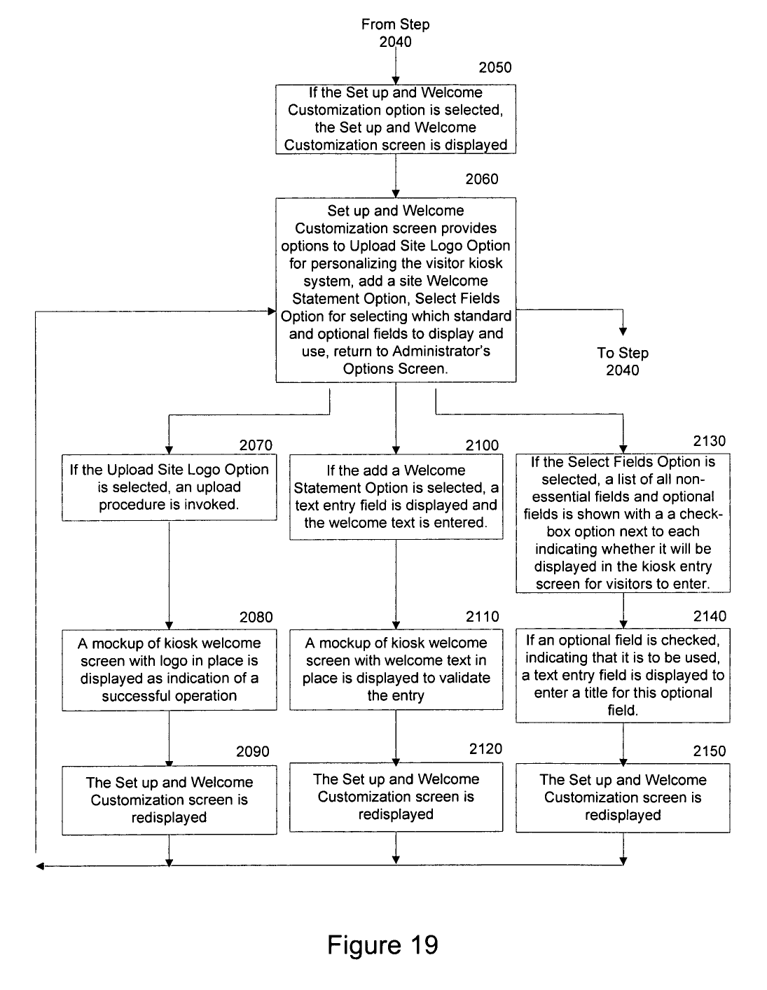

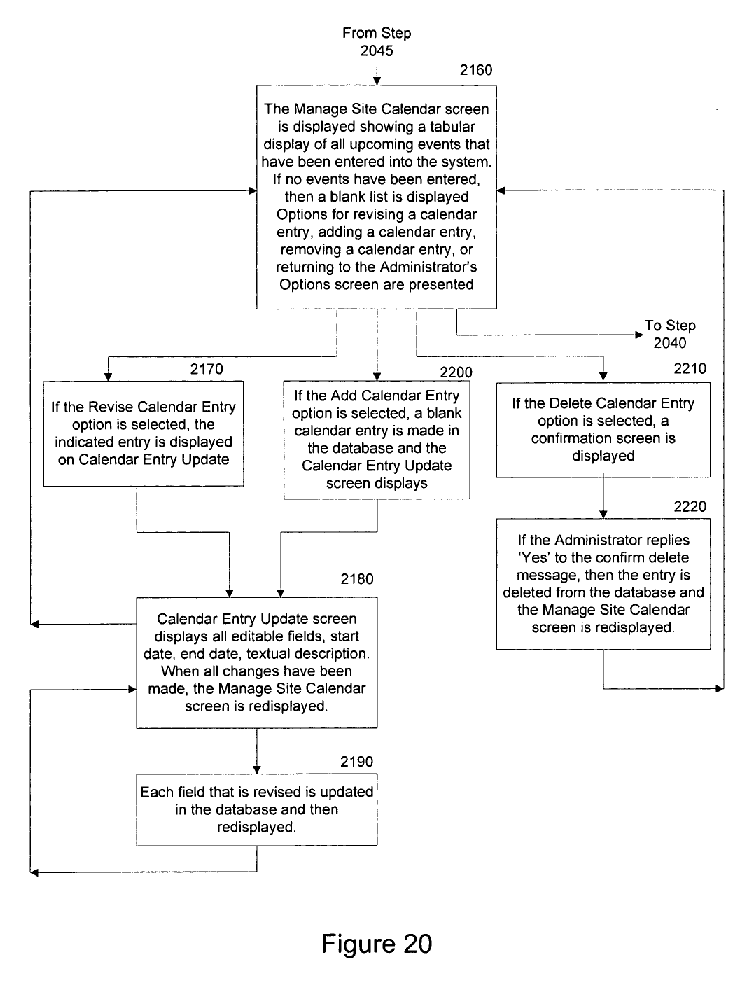

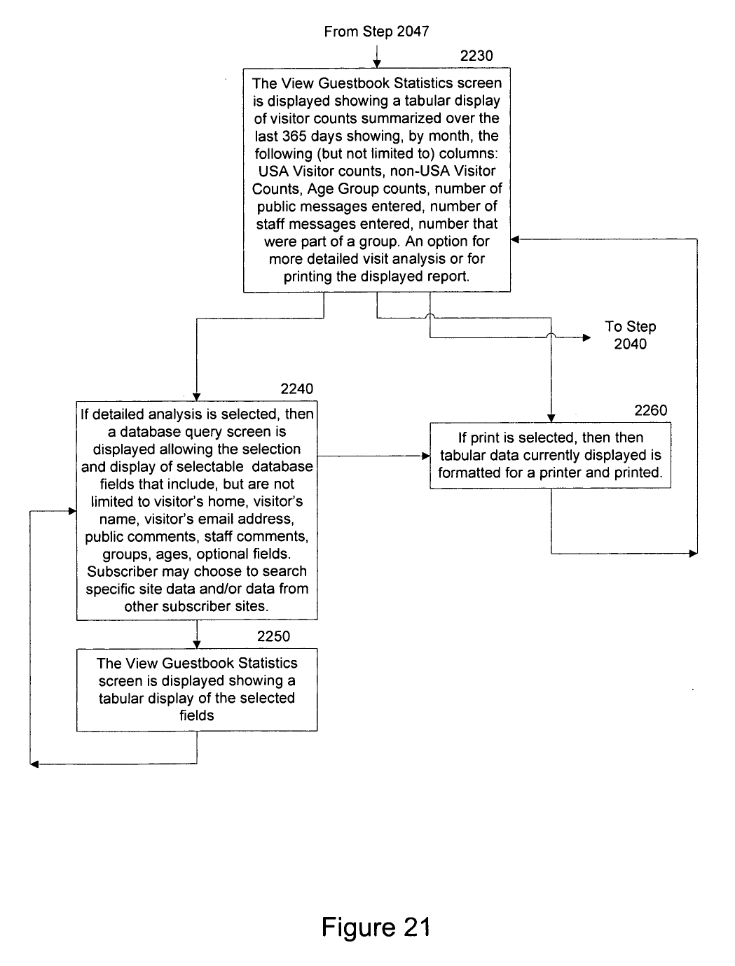

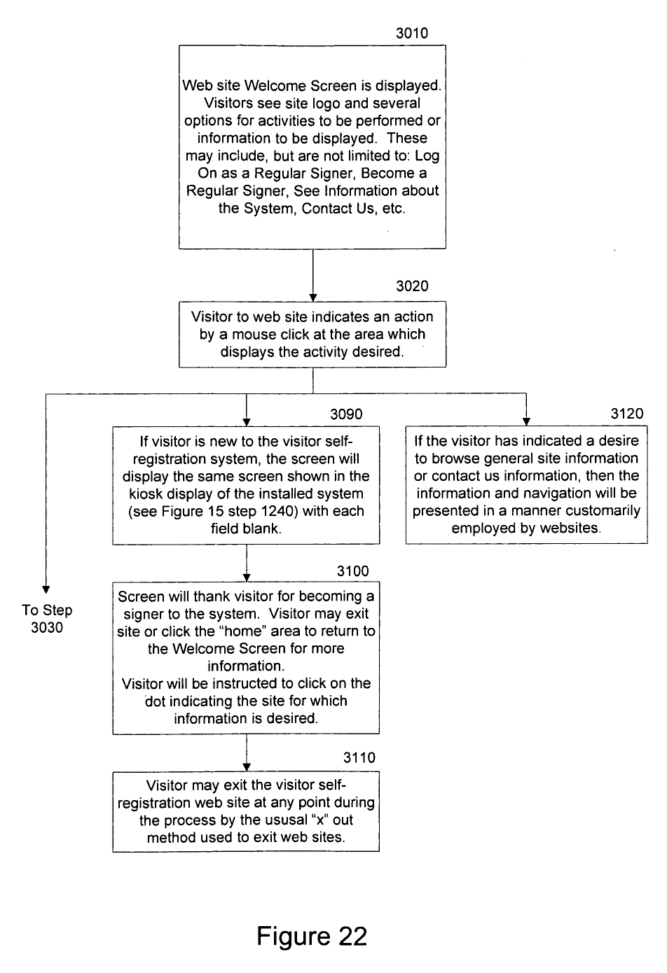

Referring to FIGS. 12-33, a system for self-registration of visitor information is shown. The term “visitor” refers to an individual who has come to a public site such as a museum, monument, park or other destination for the purpose of seeing that site. The system provides a step-by-step process that enables site visitors themselves to digitally record their registration information. The visitor registration information may be entered using both touchscreen technology and/or standard keyboard data entry methods, such as typing on a keyboard displayed on the touchscreen monitor. Such registration information would normally be entered by the visitor by hand in a paper guest book, or would require a site staff member to collect and digitally record the information.

At each step in the self-registration process, the system displays on the touchscreen instructions and/or a prompt for the visitor to enter information—e.g., an action such as touching the screen in a specific spot. In response to the indicated action being performed, the system navigates through the process to sign visitors in and to allow visitors to search the database. Visitors are able to enter their information via touching spaces on the touchscreen which are over areas displaying the various fields of the system. By touching a particular area, that field is ready to accept data from the visitor. In each field, a pop-up instruction appears which explains the data expected or required for that field. For example, a pop-up instruction may be a rectangular graphic bubble that appears on the screen when a specific area is touched. The writing within the bubble explains the process whereby information is entered in the indicated area. Where text entry is required, a keyboard may be displayed on the bottom section of the touchscreen which looks like a standard keyboard for data entry.

The visitor self-registration system incorporates a geographically-based method of entering registration information. Each visitor registration event begins by recording, in a unique manner, the geographic identity of the visitor. The visitor self-registration system is implemented on a computer system that includes a display device, an input device and a data storage device that are connected through a computer or are otherwise in communication with each other, such as through a computer network. The computer system may be a stand alone computer, or a computer or computer terminal connected to a computer network. In a preferred embodiment, the computer system is a computer that accesses a dedicated website through a global computer network such as the Internet. The dedicated website is maintained and managed by the visitor self-registration system administrators.

The display device may be any suitable graphic and/or alphanumeric display monitor, as are known in the art. Similarly, the input device may be any suitable means for navigating and selecting areas on a computer screen, including a mouse, trackball and/or keyboard, as are known in the art. In a preferred embodiment, the display and input devices are combined in a single device, such as a touchscreen monitor that displays written and graphic information on a monitor with a glass or polymer surface. The touchscreen enables the user to use his or her own finger or a specially designed stylus to navigate around and/or select the various areas displayed on the screen to enter or edit self-registration data. Touchscreen monitors suitable for use in a visitor self-registration system are commercially available from Elo Touchsystems (Menlo Park, Calif.) and other companies.

The data storage device may be local, such as a computer hard drive connected to a stand alone computer, or distributed, such as a network server or a network attached storage device attached to a computer network such as the Internet. Other data storage configurations may be used, as are known in the art. In a preferred embodiment, the data storage device is a dedicated web site maintained and managed by the visitor self-registration system administrators. The data storage device is used to store a database of input visitor self-registration information, as well as other information required for the operation of the visitor self-registration system.

In operation, the touchscreen (or other display/input device) may be provided at a subscriber site as an interactive computer kiosk. A subscriber site refers to any site that uses the visitor self-registration system. The staff at a subscriber site will turn on the touchscreen and/or computer system at the beginning of each open period for that site. Referring to FIGS. 12-17, an icon is displayed on the touchscreen which is identified as “Start System Kiosk” or similar instructional wording as shown in step 1005. Touching that icon causes a “Startup” screen to be displayed which may include a touchscreen keyboard and fields for entry of an assigned user name and password well known to those skilled the art. An example of a Startup screen is shown in FIG. 24.

In step 1010 the subscriber site staff member uses the keyboard displayed on the touchscreen to enter his or her assigned user name and password to access the dedicated web site that runs the visitor self-registration system. This action is referred to as a log on or logging on. The system receives the input user name and password in step 1020 and initiates a search of a subscriber site database to identify the specific subscriber site that is accessing the system. Once the visitor self-registration system determines the identity of the subscriber site, the system retrieves and displays a customized welcome screen, as indicated in steps 1030 and 1040. In an alternative embodiment, the log on operation can be set to occur automatically.

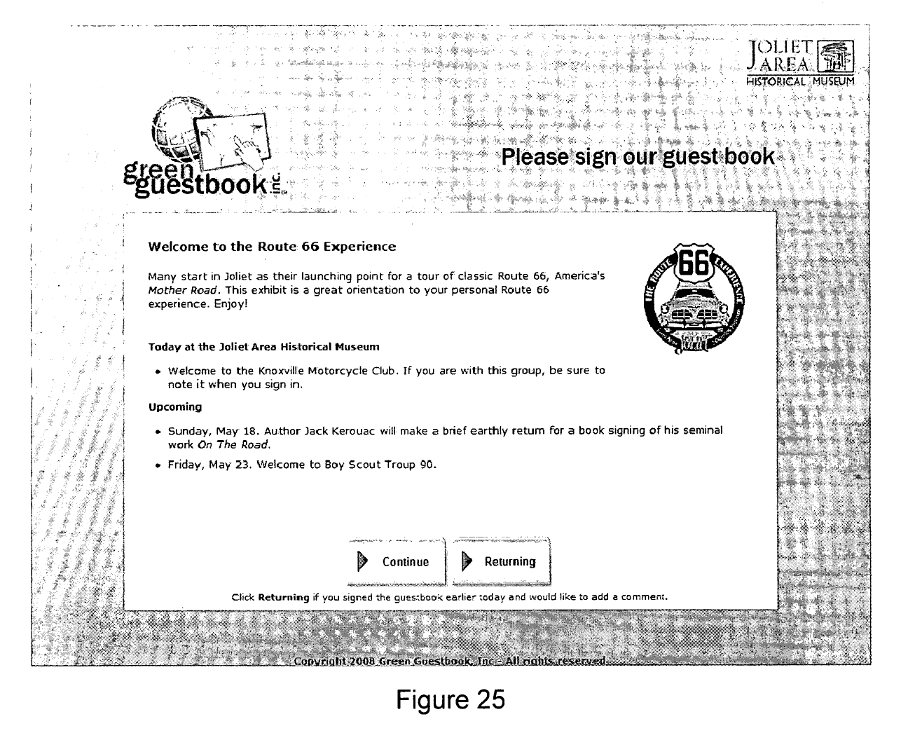

An example of the welcome screen of step 1040 is shown in FIG. 25, and may include a visitor self-registration system logo, the logo of the specific site, a greeting and/or other features which can be customized via the visitor self-registration system administrative website, as discussed below and shown in FIG. 25. The welcome screen can also include a message board having several lines of text that can be customized, which might include information about special exhibits and other events, opening and closing hours for that day, a welcome message to a tour group that is expected that day, or other site specific information that the site wishes to convey.

Visitors to the site are presented with the welcome screen, which contains an area for the visitor to touch to begin their sign in experience, as seen in step 1050. If the visitor is interested he or she will touch the screen to indicate a desire to sign on to the system. In a preferred embodiment, the touchscreen will display three options for visitors to sign on to the system. As seen in step 1060, these options will be, but are not limited to, areas displayed on the touchscreen and labeled as, for example: “New Signer”, “Returning Same Day Signer”, “Regular System Signer”. The labels on these three option areas may or may not be identified with the exact language stated above but will identify where the system already contains/stores data for the signing visitor.

If the visitor is a New Signer, the system receives the visitor's input in step 1070 and the touchscreen may display a disclaimer statement drafted in language approved by a legal representative of the site which details how the information gathered by the visitor self-registration system will be utilized. The display further prompts the visitor to confirm his understanding and agreement to the terms of the disclaimer statement by touching an appropriate area of the touchscreen, such as a button depicted on the screen and labeled “I agree.” If the visitor confirms his or her agreement, the system receives the input from the touchscreen and the process proceeds to step 1130.

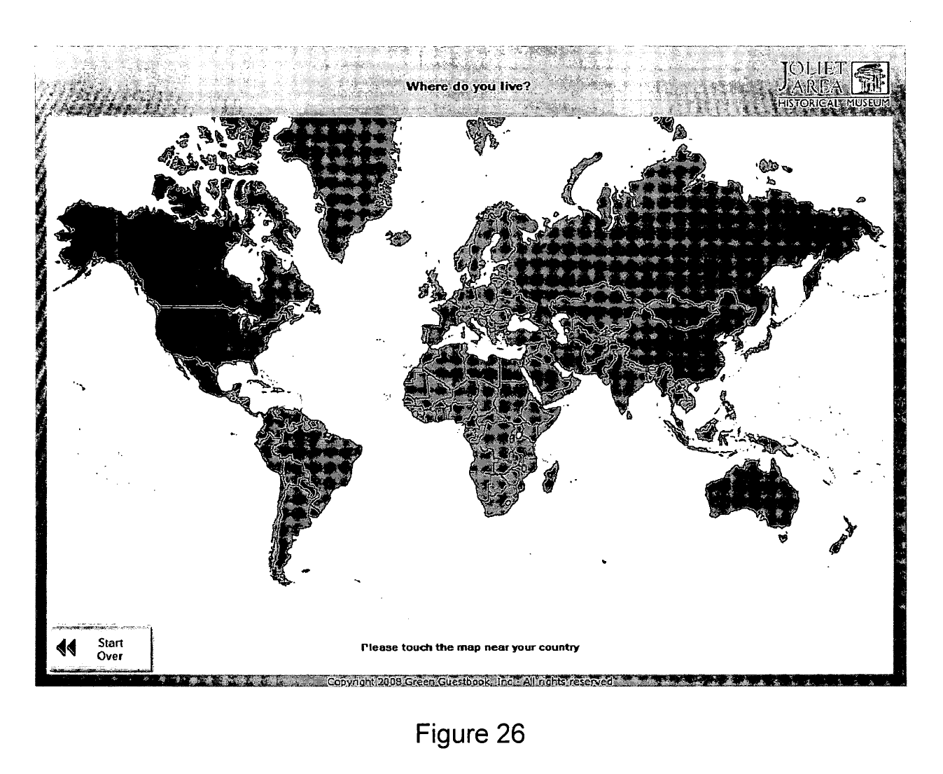

In step 1130 the system displays a first level geographic map on the touchscreen, with instructions prompting the visitor to enter a geographic location. The first level geographic map identifies one or more geographic location(s) that may be selected by the visitor by touching the corresponding area of the touchscreen. For example, the screen of step 1130 may display a world map depicting one or more countries on the map, as shown in FIG. 26. The visitor is prompted to enter his or her home country by touching the appropriate area of the touchscreen.

In step 1140, the visitor enters a geographic location by touching the appropriate area shown in the first level geographic map of the screen of step 1130. The input geographic location is received by the system, which initiates a search of a geographic database that is stored on the storage device. The geographic database contains one or more second level geographic maps, each of which is a detailed depiction of the geographic region corresponding to a geographic location identified on the first level geographic map of the screen seen in step 1130. The system displays the appropriate second level geographic map on the touchscreen with instructions prompting the visitor to enter a geographic location. The second level geographic map identifies one or more geographic location(s) that may be selected by the visitor by touching the corresponding area of the touchscreen. For example, the screen of step 1140 may display a geographic regional map of Europe that depicts one or more European countries on the map. The visitor is prompted to enter his or her home country by touching the appropriate country depicted in the display.

In step 1150, the visitor enters a geographic location by touching the appropriate area of the second level geographic map shown on the screen of step 1140. The input geographic location is received by the system, which initiates a search of a geographic database that contains a list of the names of one or more geographic locations, each name corresponding to a geographic location identified on the second level geographic map of the screen seen in step 1140.

The process proceeds to step 1230, in which the system records the visitor's input geographic location in a registration database stored on the storage device. The registration database contains all of the demographic information input by each visitor that accesses the visitor self-registration system. The system determines the number of previous visitors to that specific site that have input the same geographic location in step 1150 as the current visitor. The name of the selected geographic location and the number of previous visitors from that geographic location are then displayed on the touchscreen.

In some cases the screen of step 1140 may show a number of closely spaced geographic locations, making it difficult for the visitor to easily select the proper geographic location. For example, one or more countries depicted on the second level geographic map may be too small and/or closely crowded to permit the accurate selection of the proper country by touching the touchscreen. In such cases, the system may display a list of possible geographic locations on the touchscreen or may provide an option for the visitor to display a keyboard on the touchscreen for manual entry of the name of a geographic location, as shown in step 1160. The process then proceeds to step 1230 as described above.

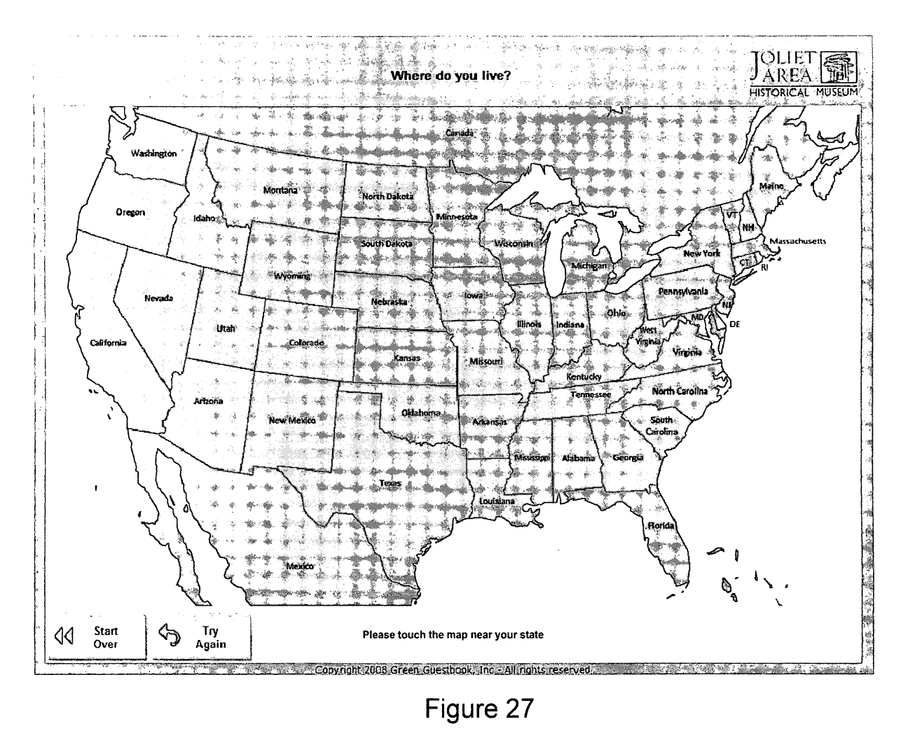

In a preferred embodiment, if the United States is input in response to the screen of step 1130, then the system provides for entry of the visitor's home State. A second level geographic map of the United States is displayed on the touchscreen in step 1140 that identifies each State. The process proceeds to step 1170, in which the visitor is prompted to enter his or her home State by touching the appropriate area of the touchscreen. An example of a screen of step 1140 is shown in FIG. 27.

The home State input by the visitor is received by the system in step 1200 and recorded in the registration database. The system searches the geographic database for the corresponding name of the State and determines the number of previous visitors to that specific site that have input the same State in step 1170 as the current visitor. A welcome is then displayed on the touchscreen in step 1210, along with a statement of how many previous visitors from that State have visited the specific site, just as non-domestic visitors are told the number of their countrymen in step 1230.

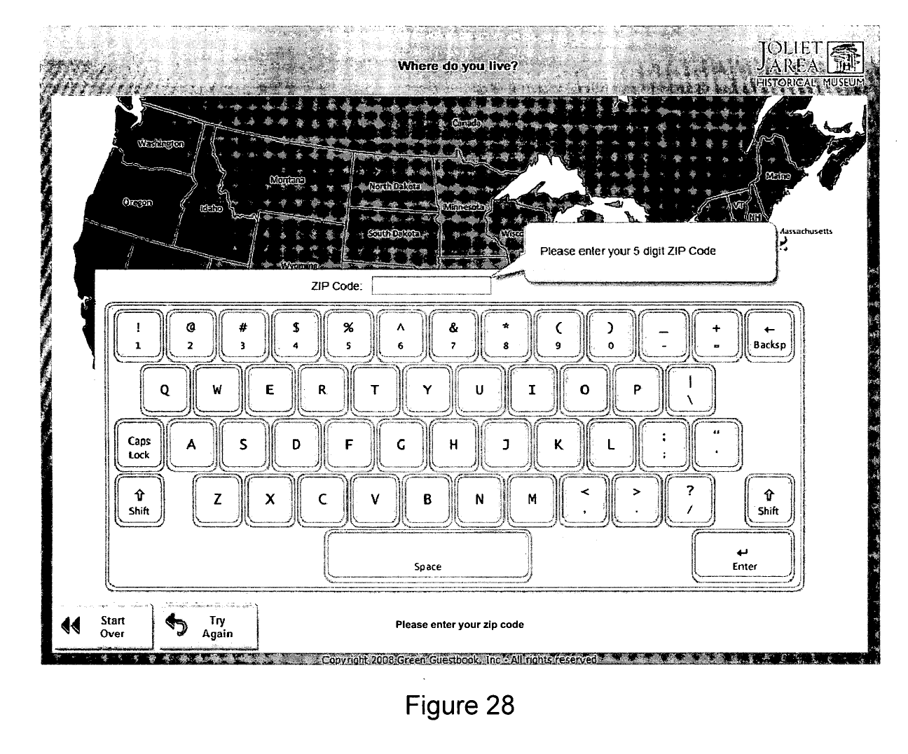

The system may also provide visitors from the United States with the option of manually entering a zip code, instead of using the touchscreen to identify their state as described for step 1170. A button may be provided on screen 1170 for display of a keyboard to allow entry of a zip code in step 1180. An example of a screen of step 1180 is shown in FIG. 28. The system receives the input zip code in step 1190, and initiates a search of a zip code database stored on the storage device to determine the State that corresponds to the visitor's input zip code. The process then proceeds to step 1210 as before.

In a preferred embodiment, when displaying the data regarding number of visitors from the visitor's selected geographic location in steps 1210 or 1230, the system also displays and requests confirmation of the geographic location that will be recorded for the visitor in the registration database. A prompt may appear as a pop-up text bubble—e.g., “Canada, if this is correct, touch here.” In the instance where the system fails to record the correct location, the visitor is provided with an option to manually enter the correct geographic location using a keyboard displayed on the touchscreen.

The visitor self-registration system may also access a mapping system which keeps track of all recognized countries in the world, as is known in the art. When a new country is formed, or an existing country changes its name, this information is automatically updated on the visitor self-registration system.

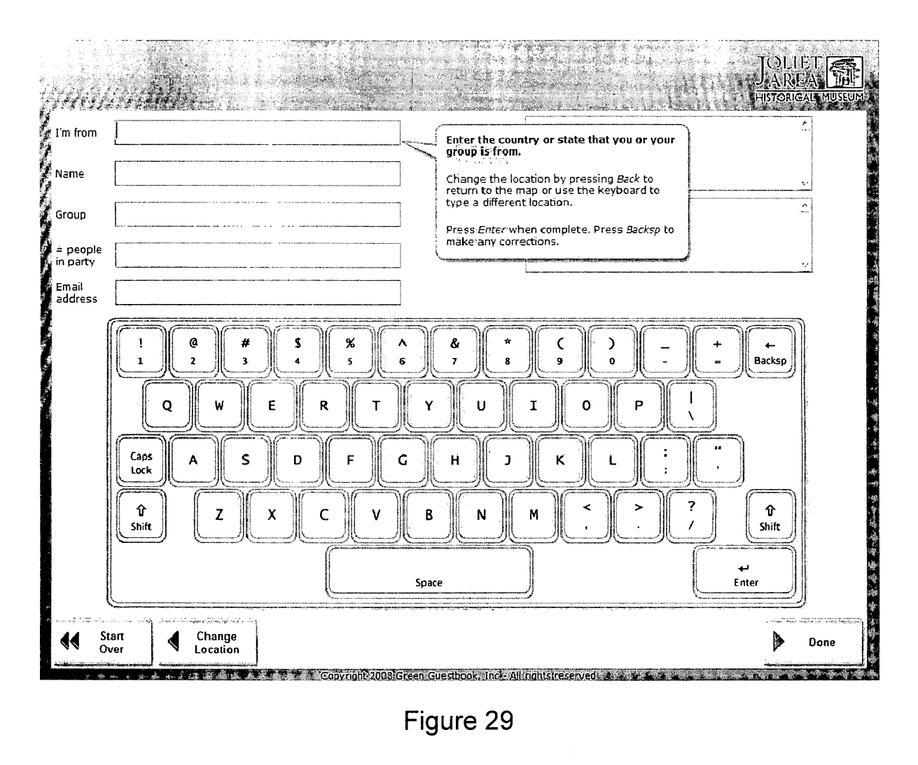

Once the visitor's home geographic location has been selected (e.g., the visitor's country or state) and the visitor has been welcomed in steps 1210 or 1230, the system will prompt the visitor to sign in to the visitor self-registration system as seen in step 1240. In steps 1250 and 1260 the visitor uses touchscreen selection and navigation, and/or keyboard text entry via an on-screen touchscreen keyboard, to select various blank fields displayed on the touchscreen and to enter or edit their individual registration information. This information can include, but is not limited to: name, email address, location of residence, date of visit (both of the previous two categories of data are automatically recorded by the system upon initial interaction with the system), number of people in the visiting party, age groups of those in party, method by which visitor heard of site, and other visitor demographic information deemed valuable by the site using the system. The system will have already recorded the date of visit and the country or state that was displayed in steps 1210 or 1230. An example of the blank sign in screen of step 1240 can be seen in FIG. 29. Additional information or instructions for the entry of information may appear as pop-up text bubbles whenever a particular field has been selected by the visitor.

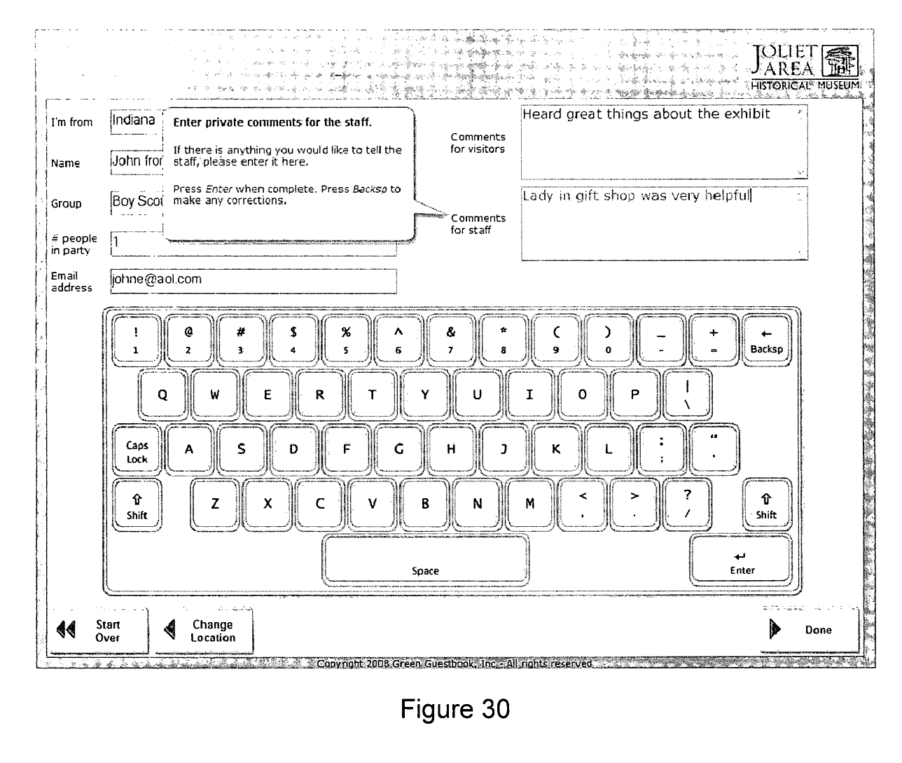

In addition to demographic registration information, the system may also provide fields for the entry of anecdotal information in steps 1250 and 1260, as shown in the screen illustrated in FIG. 30. In a preferred embodiment, the system gives visitors a chance to input anecdotal information, such as questions and comments directed to future visitors and/or the site staff regarding impressions of the site, plans for a coming trip or memories of a trip which has already taken place. The fields for visitor comments (both for future visitors and site staff) may impose a size limit, such as 500 characters of text. In the instance where a site specifically requests that its visitors be allowed to leave longer messages, this function can be changed on a site by site basis.

The visitor registration information collected by the system may be both public and private in nature. In a preferred embodiment, all subscriber sites that are part of the visitor registration system may have access to information that is designated as public. However, only the specific subscriber site where the visitor sign in takes place may have access to information designated as private. The disclaimer statement of step 1100 alerts the visitor to this circumstance.

In step 1270, the system evaluates the data entered by the visitor in step 1260 to determine if the minimum required information was entered by the visitor and duly recorded by the system. This minimum required information may be, but is not limited to, the name (first name only is accepted by the system) and number of people in a party (party refers to a group of visitors who have come to the site together). The minimum required information may also include the date of the visit and the location of the visitor's residence, both of which may be automatically recorded by the system based on the system's internal calendar and the geographic location identified in steps 1210 or 1230. If the minimum required information was not entered or previously recorded, the system will display instructions on the screen which direct the visitor to enter the required data as seen in step 1270.

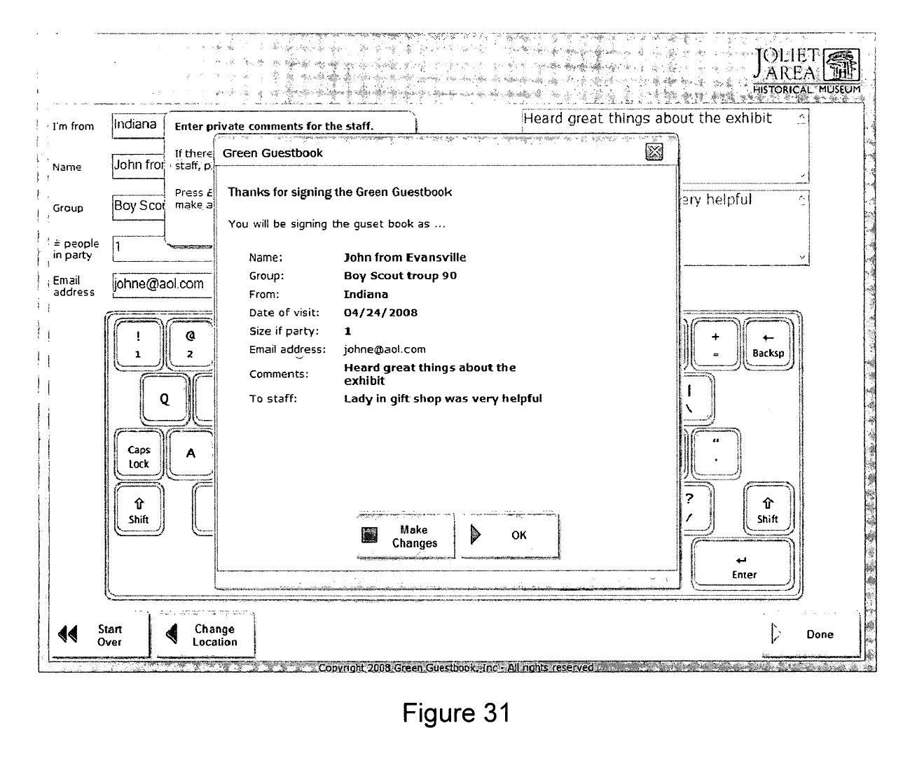

In the case where the minimum required information has been sufficiently entered, the process proceeds to step 1280 and the system displays a confirmation screen on the touchscreen summarizing the information entered by the visitor and permitting the visitor to accept or edit the recorded data. An example of a confirmation screen of step 1280 is illustrated in FIG. 31. Buttons are provided on the screen allowing the visitor to edit the information by returning to step 1270, or to confirm that the information is correct.

If the visitor indicates in step 1280 is that the data is not correct and the visitor desires to edit the entered data, the screen will then return to step 1260, whereby the visitor is again given the option to accept or edit the displayed data as seen in step 1270.

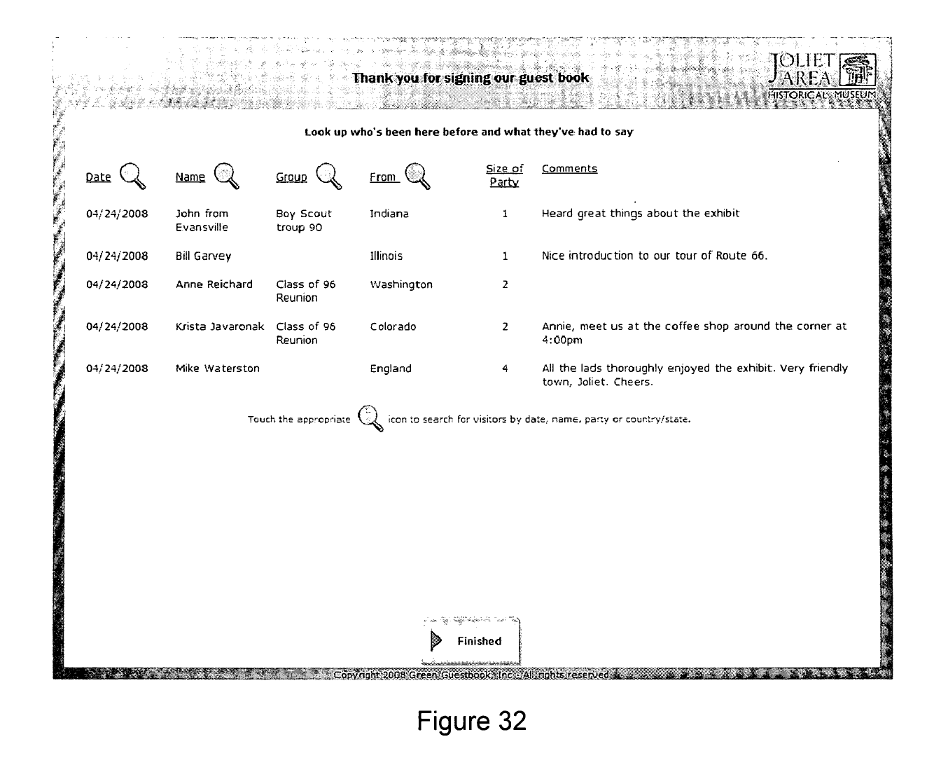

If the visitor confirms in step 1280 that the data is correct, the process proceeds to step 1290 and the system displays a screen on the touchscreen that lists the registration information entered by the most recent group of visitor—e.g., the ten most recent entries to the system for the specific site as shown in the screen illustrated in FIG. 32. The visitor may then indicate via a touch on the screen that the session is complete in which case the screen returns to step 1040 and will again display the welcome screen of FIG. 25.

Alternatively, in step 1290 the visitor may choose to search the registration database for previous entries related to the specific site. Visitors are sometimes hesitant to page through a written guest book, but will more readily search for information on other visitors in an electronic format. Visitors can look up who has visited from their home country or State. For those traveling in groups, members of the group may leave and retrieve brief messages for each other using the fields for entry of anecdotal information.

As shown in FIG. 32, instructions may be provided on the screen which indicate that a visitor can touch an icon associated with each field of steps 1250 and 1260 that is available for searching. In a preferred embodiment, the icon is a recognizable symbol for search activity, such as a magnifying glass. Available search fields may be, but are not limited to, the date of visit, the geographic location, name or group size. Some fields may not be available for searching by visitors, such as comments for the site staff.

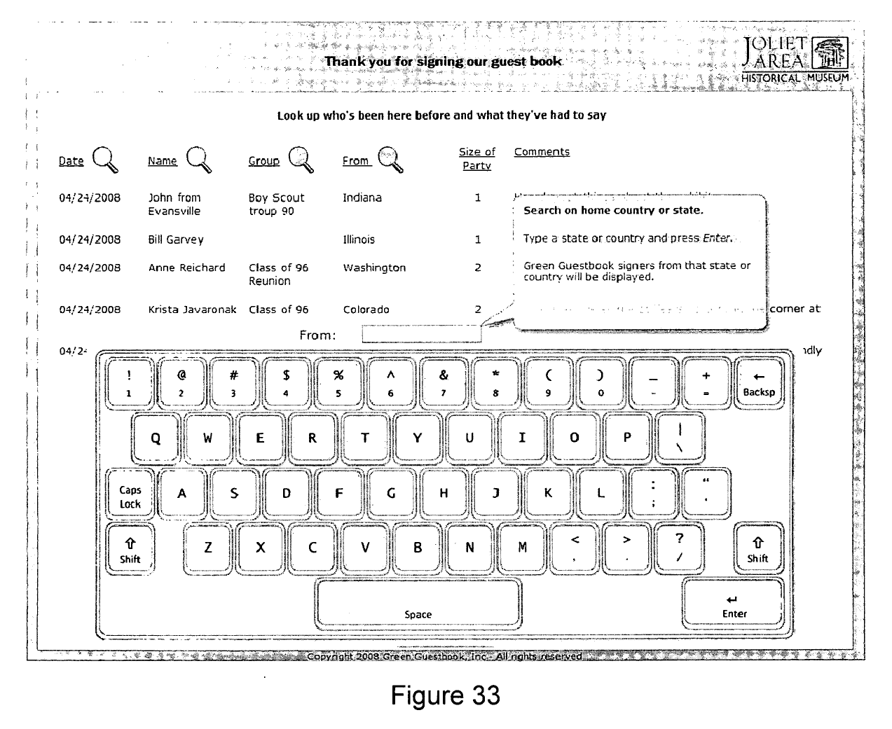

In step 1300, the input field is received by the system which proceeds to step 1310 and displays a new field and a touchscreen keyboard for entry of search text. A pop-up text bubble may be used to confirm the search field and provide additional instructions. An example of the search screen of step 1310 is shown in FIG. 33.

The input search text is received in step 1320 and the system initiates a search of the registration database for matching entries. The ten (or another number determined by the site or system administrator) most relevant entries are then displayed similarly to step 1290. The information displayed on the search results screen may be limited to all non-private information which may include, but is not limited to, date of visit, geographic location, name, group, number of people in party, and comments left for other visitors. In a preferred embodiment, private information such as email address, age group of party members and comments left for staff are not searchable nor is such information displayed in step 1320. Once the search is complete, the visitor may return to step 1290 and initiate a new search using a different search text and/or search field, or may elect to end the session at which point the screen will return to step 1040 and display the welcome screen of FIG. 25.

If visitor is not New Signer and has previously entered his or her registration information, he or she may input in step 1060 that he or she is a Same Day Returning Signer, the input is received by the system in step 1080 in which a keyboard is displayed on the touchscreen along with instructions prompting the visitor to enter his or her name similarly to the visitor's first encounter with the system in step 1240. In step 1110, the input name is used to search the system's database of visitor registration information and the process proceeds to step 1260 in which the system displays the visitor's registration information as previously entered that day. The process continues from step 1270 as described above, allowing the visitor to edit or confirm the previously entered information.

Alternatively, the returning visitor may indicate in step 1090 that he or she is a Regular System Signer. The input is received in step 1090 and a keyboard is displayed on the touchscreen along with instructions prompting the visitor to enter his or her email address. In step 1120, the input name is used to search the system's database of visitor registration information and the process proceeds to step 1260 in which the system displays the visitor's previously entered registration information. The process continues from step 1270 as described above, allowing the visitor to edit or confirm the previously entered information. Returning signers of either type do not traverse through steps 1130 through 1250.

For security reasons, it is preferred that the visitor self-registration system is a self-contained system, password protected, and not externally accessible (e.g., via a network such as the Internet or any other system) without approval from the specific site. Where the visitor self-registration system is run via a dedicated Internet website, both the visitor self-registration website and any other dedicated website which administers it are password protected and do not have published website addresses. Visitors would be told in the disclaimer statement seen on the screen of step 1100 that their information is readable by other visitors to the site and by staff but not by the outside world in any way. Confidential information such as email addresses and age groups would only be available to site staff, and would not be searchable by the public or by other subscriber sites.

It will be apparent to those of skill in the art that the visitor self-registration system may be modified to include additional steps for displaying increasingly detailed geographic maps to allow the visitor to input specific geographic locations and/or other demographic information, such as the visitor's home State, home city, zip code, etc. In addition, the geographic database may be a single database or may comprise multiple separate databases—e.g., for second or higher level (if any) geographic maps and lists of names of geographic locations. Similarly, the registration database may be maintained as a single database, or as multiple separate databases—e.g., for each information field.

The visitor self-registration system may also be provided with an administrative component for site staff and other system operators. In particular, where the visitor self-registration system is operated via a dedicated Internet website, the administrative functions are provided by a second, dedicated website which is accessible only by subscribers and system operators. Each subscriber site may assign one or more administrators who will be given password access to an administrative website which provides the ability customize the various customizable features within the visitor self-registration system specific for that site. The customizable features of the visitor self-registration system include, but are not limited to, the site logo on the welcome screen of step 1040, the unique site statement on the welcome screen, and the message board on the welcome screen highlighting special offerings or welcoming a group. In a preferred embodiment, the logo and site statement are customizable but remain displayed on the screen every time the site accesses the visitor self-registration system. The special message sections are set with expiration dates so that a message will expire within a specified period of time. This simplifies the work of the site staff such that messages do not have to be removed. When posted, a time duration can be set after which the message will disappear or be replaced with a generic message already drafted by the Site Administrator. The administrative website is never to be accessed by the general public and will be password protected and have an unpublished web address.

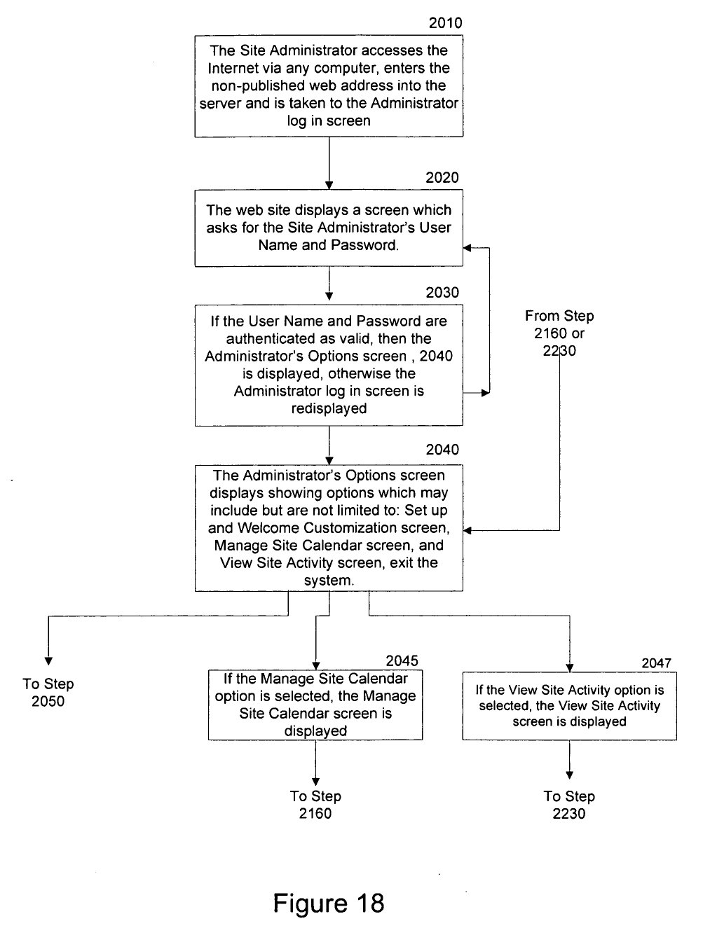

Referring to FIGS. 18-21, a Site Administrator (or other system operator) begins an administrative session by accessing the administrative website through an Internet browser using a computer or other device capable of connecting to the Internet, as shown in step 2010. The administrator enters the non-published website address into the server and is taken to the administrator log in screen for the visitor self-registration system. In step 2020, the dedicated website displays a screen which asks for the Site Administrator's User Name and Password in a manner similar to that described for step 1010 and shown in FIG. 24. The system searches the subscriber site database in step 2030 to authenticate the input user name and password. If the user name and password are not found in the subscriber site database or are otherwise incorrect, the process returns to step 2020 and the administrator log in screen is redisplayed. If the user name and password are authenticated as valid, then the process proceeds to step 2040 and the system displays the administrator's option screen. The administrator's option screen displays the welcome screen described for step 1040 and shown in FIG. 25, with highlighted areas indicating fields that are available for customization. The Site Administrator may select from various options for customization, including, but not limited to, Set up and Welcome Customization screen, Manage Site Calendar screen, and Manage Site Activity screen.

If the Site Administrator selects the Set up and Welcome Customization screen option, the system displays the Set up and Welcome screen in step 2050. This screen provides options to upload the site's logo and other information for customizing the kiosk display of the visitor self-registration system. These options may include, but are not limited to; Upload the Subscriber Site's Logo, Add a Site Welcome Statement, Select Which Standard and Optional Fields to Display on the kiosk Welcome Screen, and Return to the Administrator's Options Screen.

If Site Administrator selects the Upload the Subscriber Site's Logo option in step 2060, the system facilitates the insertion of a new logo for the subscriber site into the welcome screen of step 1040. The Site Administrator provides a logo in step 2070, which is uploaded to the dedicated web site that runs the visitor self-registration system. In step 2080, a mockup of the welcome screen of step 1040 including the new logo is then displayed to confirm the upload and for review by the Site Administrator. The process then proceeds to step 2090, in which the system displays the Set up and Welcome screen and returns to step 2060. The new logo will now be displayed in the welcome screen on the kiosk each time the visitor self-registration system is accessed, until and unless the Site Administrator repeats steps 2070 through 2090.

If the Site Administrator selects the Add a Site Welcome Statement option in step 2060, the system facilitates the insertion of new welcome text for the subscriber site into the welcome screen of step 1040. In step 2100, a field for text entry is displayed and the Site Administrator inputs the new text for the welcome screen which is uploaded to the dedicated web site that runs the visitor self-registration system. In step 2110, a mockup of the welcome screen of step 1040 including the new welcome text is then displayed to confirm the upload and for review by the Site Administrator. The process then proceeds to step 2120, in which the system displays the Set up and Welcome screen and returns to step 2060. The new welcome text will now be displayed in the welcome screen on the kiosk each time the visitor self-registration system is accessed, until and unless the Site Administrator repeats steps 2100 through 2120.

In the instance where the Site Administrator selects the Select Which Standard and Optional Fields to Display option in step 2060, a Select Field Options screen is displayed which allows the Site Administrator to modify the visitor registration information that is collected by the system. In step 2130, the Select Field Options screen displays a list of all non-essential fields and optional fields in the screen described for step 1240 and shown in FIG. 29. In the preferred embodiment the essential fields include: the geographic location as input by the visitor in steps 1130 to 1230 described above; name (first name only will be accepted); the date of visit (which is automatically recorded by the visitor self-registration system but is not displayed on the Entry Screen as seen in FIGS. 29 and 30); and number of people in the party.

The list of all non-essential and optional fields is provided with a series of check-boxes, radio buttons, or other selection indicia that permit the Site Administrator to select and unselect the fields desired to be included in the visitor self-registration system for that specific site. All non-essential fields which have been anticipated and named by the visitor self-registration administrators are displayed with an identifying name. These may include, but are not limited to, email address, age groups of party members, comments left for future visitors, comments left for site staff, and how did you hear about the site. The Site Administrator uses the check-boxes to select the non-essential fields desired to be included by the system. These checked fields will appear as named on the screen of step 1240 as described above and shown in FIG. 29.

In an alternative embodiment, the visitor self-registration system also permits the addition of optional fields that may be defined by the Site Administrator for input of visitor registration information. The number of optional fields is preferably limited to three Site Administrator definable fields, but may include more or fewer fields and still be within the scope of the design of the system described herein. In step 2140, the Site Administrator may check a box next to an optional field whereby the field will be displayed with an area highlighted in which the Site Administrator may enter text to name that field. The Site Administrator may choose to name all three optional fields or a smaller number of fields, or to select and name no optional fields. Since these fields are optional, it is possible for different subscriber sites to collect different types of visitor registration information. Unless otherwise requested, the optional field information collected by the visitor self-registration system will not be available to all subscriber sites on the administrative web site. Only those essential and non-essential fields which were predefined by the system will be available on the registration database which subscriber sites may access to obtain data from other subscriber sites as described below for step 2240.

Once all non-essential fields and optional fields are selected and defined by the Site Administrator, the selected fields are displayed in a mockup of the screen of step 1240. Check-boxes are provided for the Site Administrator to approve or edit the displayed fields. If “edit” is selected, process returns to step 2130. If “approve” is selected, the system displays the completed, customized screen of step 1240. The process then proceeds to step 2150, in which the system displays the Set up and Welcome screen and returns to step 2060.

In the instance where “Manage Site Calendar” is selected in the administrator's option screen of step 2040, the system allows the Site Administrator to modify a site specific calendar database that is stored on the storage device. The calendar database contains one or more calendar entries that include, but are not limited to, a start date, an end date, and a text message to be displayed on the welcome screen of step 1040. Examples of such text messages include descriptions of upcoming or current exhibits and events, or other information that the specific site wishes to convey. The system will automatically display calendar entries on the welcome screen described in step 1040 on the start date. Calendar entries will similarly be deleted from the system automatically when the end date has passed.

If “Manage Site Calendar” is selected in 2040, the system receives the input in step 2045 and displays the Manage Site Calendar screen in step 2160. The Manage Site Calendar screen shows a tabular listing of all calendar entries for upcoming events sorted by date, that have previously been entered into a calendar database for the specific site. The data for each upcoming event can be entered by the Site Administrator by traversing through the tabular display utilizing the mouse click procedure well known to those skilled in the art. Within the Manage Site Calendar screen, the Site Administrator can Revise a Calendar Entry, Add a Calendar Entry, Remove a Calendar Entry, or Return to the Administrator's Option Screen as seen in step 2040.

If “Revise Calendar Entry” option is selected in step 2160, the calendar event selected by the Site Administrator is displayed in step 2170 as a Calendar Entry Update screen. The Calendar Entry Update screen shows all editable fields in the selected calendar entry, which may include, but are not limited to, start date, end date, and textual description. In step 2180, the Site Administrator modifies the information in one or more editable fields. The system then updates the calendar database in step 2190 and redisplays the Calendar Entry Update screen of step 2170 with the modified calendar entry. When all changes are completed, the process returns to step 2160 and the Manage Site Calendar screen is redisplayed.

If “Add a Calendar Entry” is selected in step 2160, the system creates a new blank calendar entry in step 2200. The new entry is displayed in the Calendar Entry Update screen and the process proceeds to step 2180 to allow the Site Administrator to enter the desired text in the editable fields. The system then updates the calendar database in step 2190 and the process proceeds as previously described.

If “Delete Calendar Entry” option is selected in step 2160, the system displays a confirmation screen in step 2210 that shows the selected calendar entry with a check-box for the Site Administrator to confirm the option to delete the entry. If the check-box is checked, that entry is deleted from the calendar database in step 2220 and the process returns to step 2160 and the Manage Site Calendar screen is redisplayed. If no further modifications of the calendar database are required, the Site Administrator may select the Return to the Administrator's Option Screen option and the process returns to step 2040.

If “View Site Activity” is selected in step 2040, the process proceeds to step 2230 and the system initiates a search of the registration database and displays a screen showing a tabular list of visitor counts summarized over the last 365 days showing, by month, information which can include, but is not limited to, U.S. visitor counts, Non-U.S. visitor counts, age group counts, number of public messages entered, number of staff messages entered, number of visitors that were part of a named group. Within the displayed list, options are provided to access more detailed information regarding that category or field of entry.

If a detailed analysis is selected in step 2230, the Site Administrator may conduct a further search and/or sorting of the information in the registration database, and may format the information as a chart or report. In step 2240, a database query screen is displayed which permits the Site Administrator to search and/or sort the data collected in the registration database for the specific site or for other subscriber sites. If information from other subscriber sites is desired, the Site Administrator will be instructed to enter subscriber site search criteria in step 2240 which may included but is not limited to: all subscriber sites, sites within same state, sites within same country, or other site search criteria which may be determined by the system administrator for the visitor self-registration system. The information obtained from the registration database may be displayed in step 2250 in the form of charts or reports, as would be available in any standard database system well known to those skilled in the art. Alternatively, the information may be formatted and output to a printer in step 2260. If no further review of the registration database is required, the Site Administrator may select the Return to the Administrator's Option Screen option and the process returns to step 2040.

Certain information in the registration database may also be accessed by visitors remotely via the Internet through a public website that is maintained by the administrator of the visitor self-registration system. This feature of the system allows visitors to revisit their travel experience, learn more about the subscriber site and read the comments of other visitors to the subscriber site. Thus, the visitor self-registration system may also include a public website which is accessible to anyone who is interested in learning about the system or in becoming a regular signer to the system.

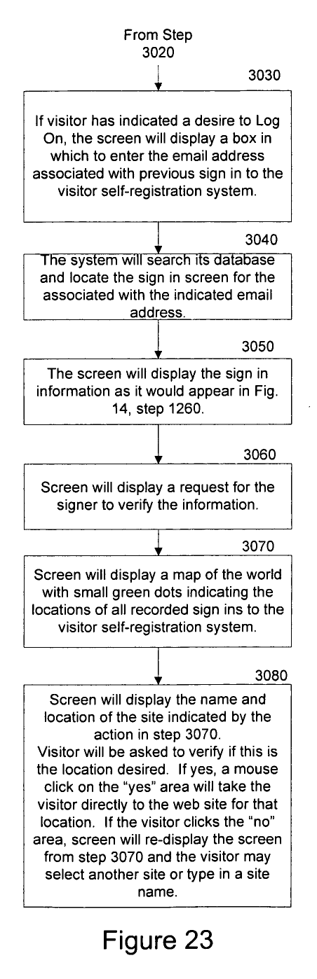

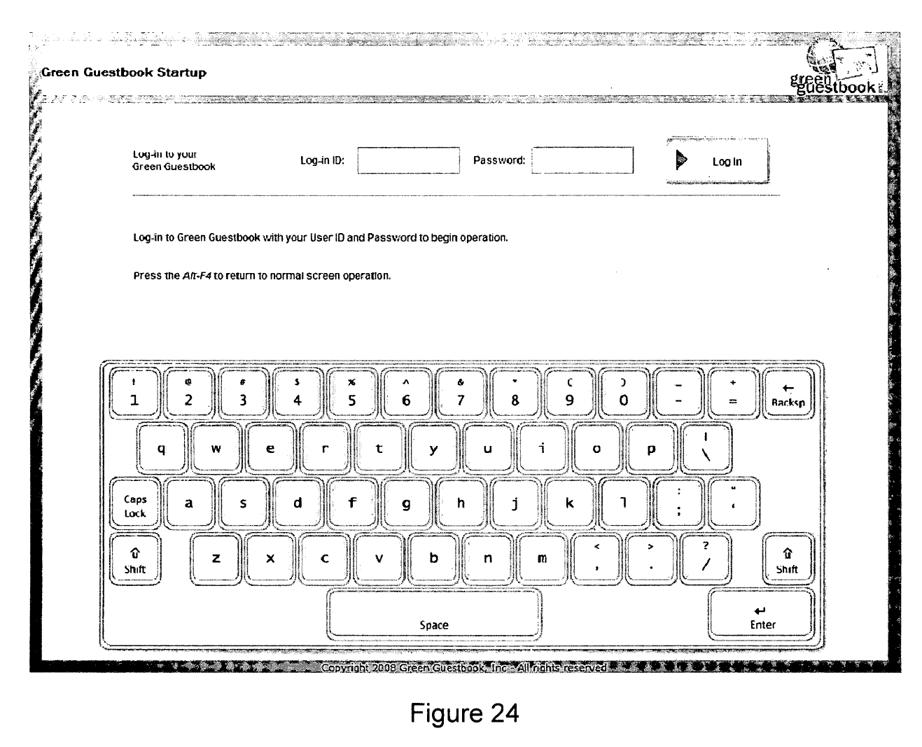

Referring to FIGS. 22 and 23, a visitor (or other interested party) may access the public website via an Internet browser using a remotely located computer or other device that is connected to the Internet, as are known in the art. In step 3010 the public website displays a welcome screen which provides several options for activity within the website. These options may include, but are not limited to: Log On as a Regular Signer, Become a Regular Signer, See Information about the System, Contact Us.

The visitor selects an option in step 3020 by the use of a mouse click on the icon or area of the screen which represents the desired activity described in step 3010. If Log On as a Regular Signer is selected, the process proceeds to step 3030 and the system displays a text box wherein the visitor can enter the email address that he or she previously input in step 1090 or 1250 described above, which is stored in the registration database and is used by the system to specifically identify the visitor.

The input email address is received in step 3040 and the system initiates a search of the registration database to identify the visitor registration information associated with the entered email address. In step 3050, the system then displays the visitor registration information as it would appear in the screen of step 1260, as described above and shown in FIG. 30. The process proceeds to step 3060 in which the system displays a request for the visitor to verify the registration information to proceed with the session. Verification of the visitor registration information may be performed by a mouse click or other indicator well known in the art.

If the visitor verifies the registration information, the system proceeds to step 3070 and displays a map with dots or other indicia which identify the locations of the various subscriber sites where the visitor has visited and signed on to the system, as described above for steps 1040 to 1340. The visitor may obtain additional information about each identified subscriber site in step 3080, by clicking or otherwise selecting the appropriate dot on the map. The system then initiates a search of the system database to determine the identity of the selected subscriber site, and displays the name and website address for that subscriber site. The visitor will be given the opportunity to verify that subscriber site's name with option check-boxes labeled “yes” and “no”. If the location is verified, a mouse click in the “yes” check-box will take the visitor directly to the website maintained by that subscriber site, if any. In the event the subscriber site does not maintain a website, the system will display the basic information about the location that may be stored in the subscriber site database, if any, such as the physical address and logo of the subscriber site.

If the visitor indicates that he or she is new to the visitor self-registration system by selecting the Become a Regular Signer option in step 3020, the process proceeds to step 3090 and the system displays a blank sign in screen similar to that of step 1240, described above and shown in FIG. 29. The visitor may then navigate from one field to the other and enter the appropriate information in each field as previously described for steps 1240 through 1280. Because this session is not a sign in at a subscriber site, the information collected by the sites such as number of people in the party and comments sections, are not collected in step 3090.

Once sign in is completed, the registration information is input into the registration database and the process proceeds to step 3100 in which the visitor may return to the welcome screen of step 3010, or exit the website. In addition, the user may exit the public website at any point in the process using the various features that may be provided by the web browser, as are known in the art.

Alternatively, if the visitor does not wish to Log On as a Regular Signer or Become a Regular Signer, he or she may simply browse through the general information provided by the public website or contact the administrators of the visitor self-registration system by selecting the See Information about the System and Contact Us options, and/or may navigate through any other features that may be provided by the public website in the customary manner known in the art.

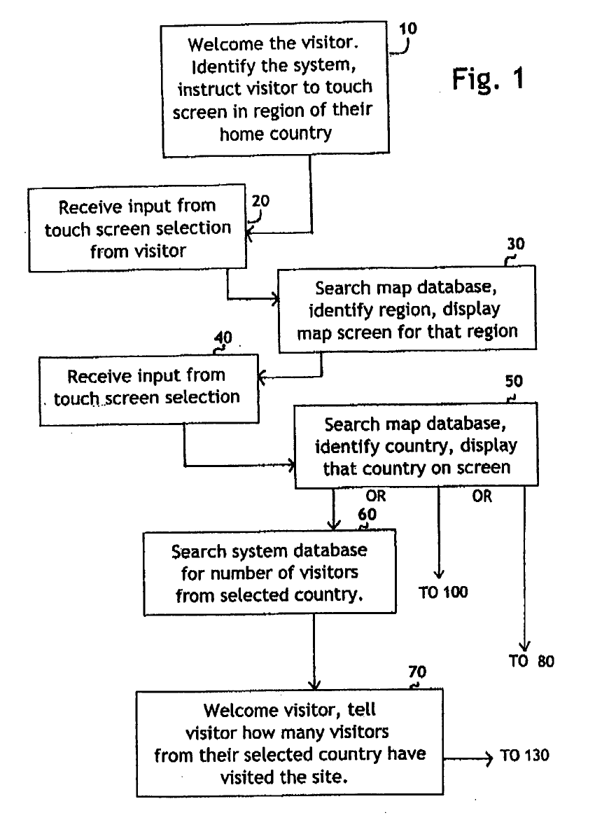

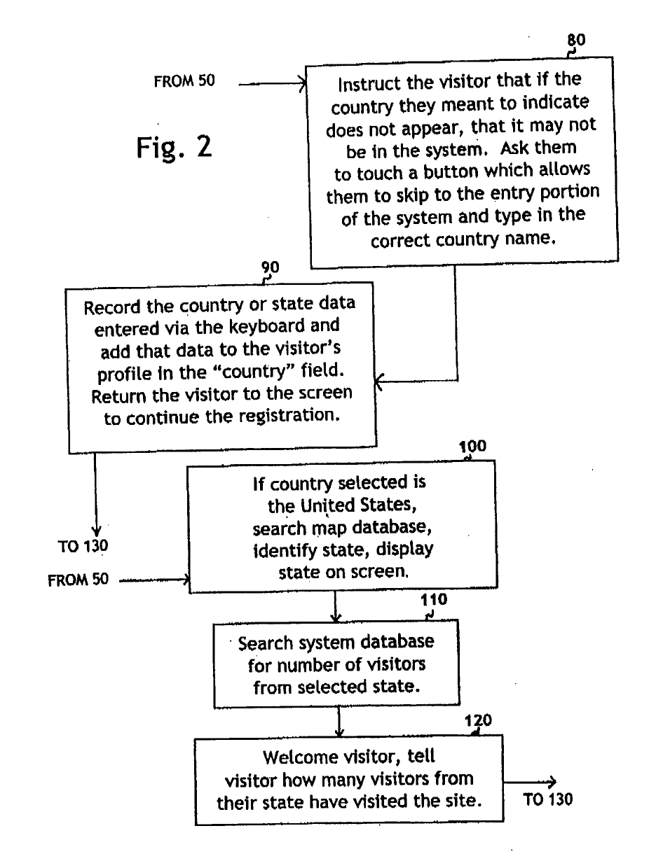

Referring to the drawings, FIGS. 1 to 11 illustrate an alternative embodiment of a visitor self-registration system and show the steps which take the visitor from his or her initial approach to the kiosk through to their welcome. The welcome is geographically personalized based on the touchscreen data entered regarding the visitor's place of origin.

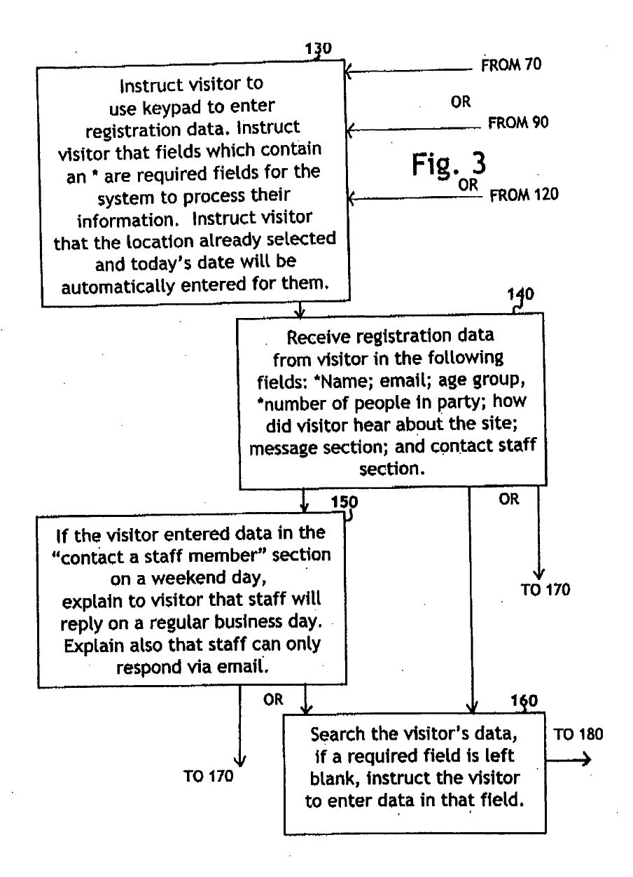

Referring to the drawings, FIG. 3 shows the steps which collect the visitor's more specific data, enable the visitor to leave a message, enable the visitor to leave a message for a staff member, and begin the check to see that the data entered is complete.

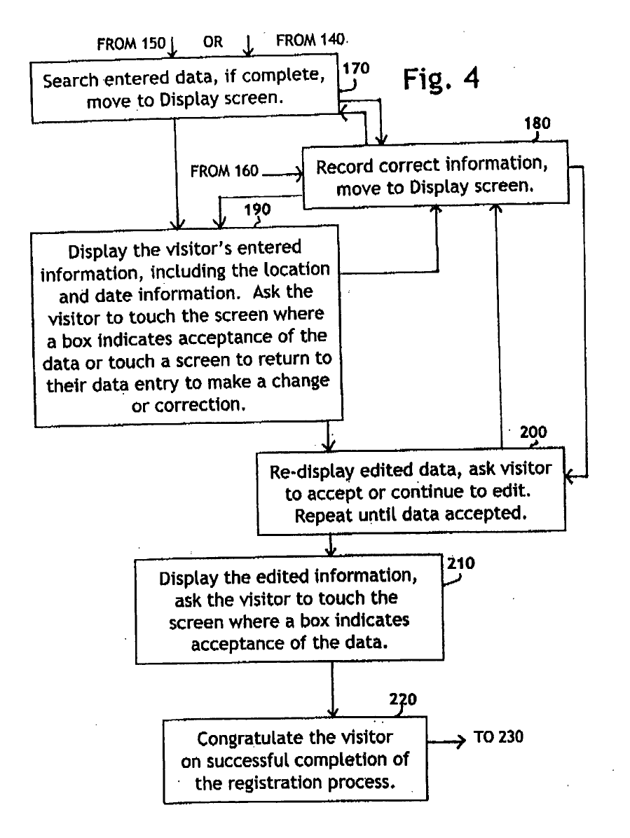

Referring to the drawings, FIG. 4 shows the steps which edit the visitor's entered data and verify that all data is correct.

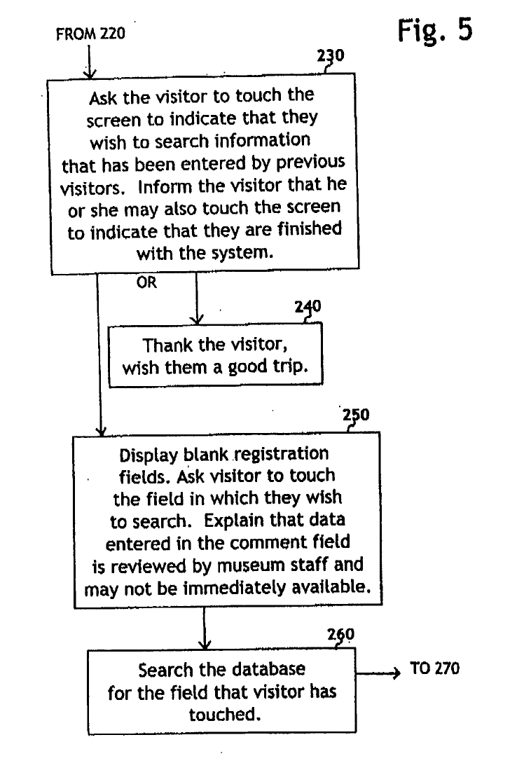

Referring to the drawings, FIG. 5 shows the steps which a visitor may choose to use to search data entered previously by other visitors.

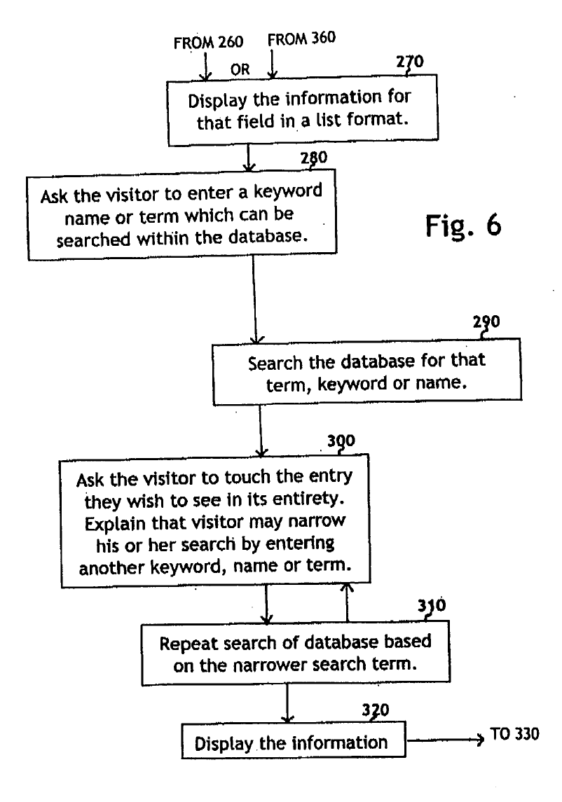

Referring to the drawings, FIG. 6 shows the steps which a visitor may choose to use to narrow and continue a search and to display the desired information.

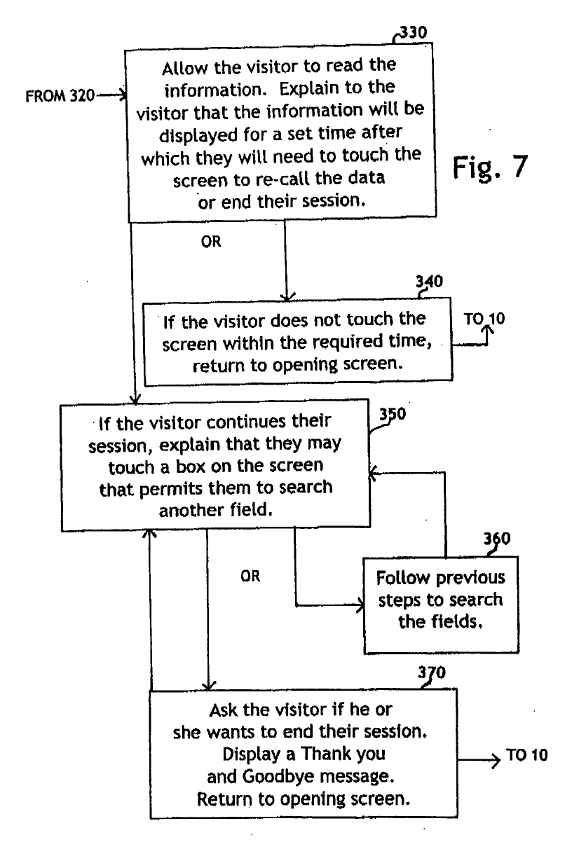

Referring to the drawings, FIG. 7 shows the steps which a visitor may choose to use to continue or end his or her search session, and displays a “Good-bye” message to a visitor who has ended a session.

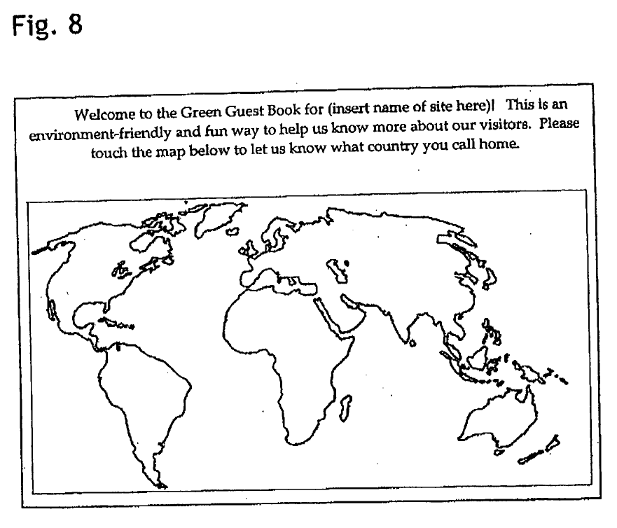

Referring to the drawings, when step 10 is executed, the screen shown in FIG. 8 is an example of that seen by the visitor.

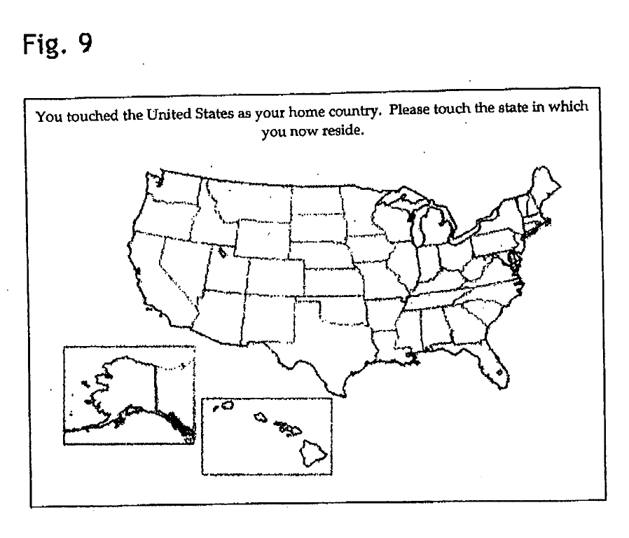

Referring to the drawings, when step 100 is executed, the screen shown in FIG. 9 is an example of that seen by the visitor.

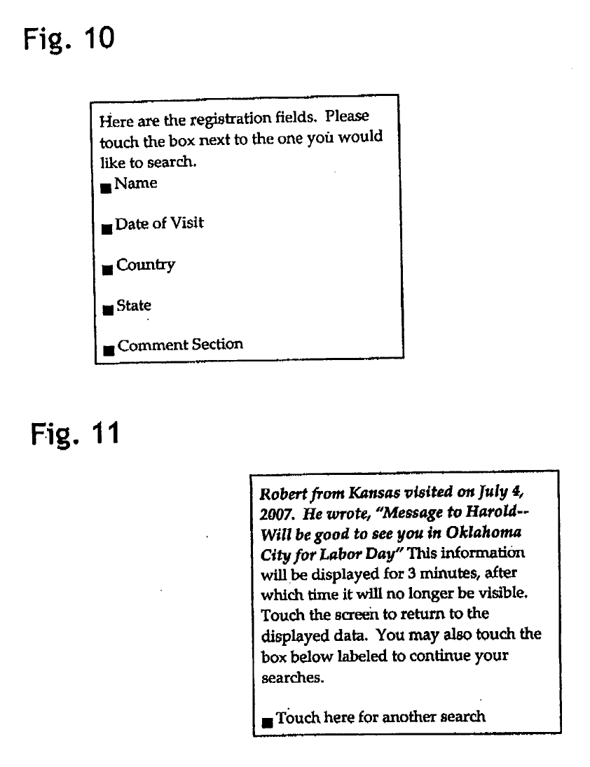

Referring to the drawings, when step 250 is executed, the screen shown in FIG. 10 is an example of that seen by the visitor.

Referring to the drawings, when step 320 is executed, the screen shown in FIG. 11 is an example of that seen by the visitor.

While various embodiments have been described, it will be apparent to those of ordinary skill in the art that many more embodiments and implementations are possible within the scope of the invention. Accordingly, the invention is not to be restricted except in light of the attached claims and their equivalents.

What is claimed is:

1. A method for registration of information in a database, comprising the steps of:
providing a first database for recording information;
providing a touchscreen display;
displaying on the touchscreen display a first level geographic map depicting a plurality of geographic locations;
selecting a first geographic location from the plurality of geographic locations depicted on the first level geographic map by touching the area of the touchscreen display displaying the first geographic location;
providing a second database comprising at least one second level geographic map depicting a plurality of geographic locations, each second level geographic map corresponding to a geographic location depicted on the first level geographic map;
displaying on the touchscreen display the second level geographic map that corresponds to the first geographic location;
selecting a second geographic location from the plurality of geographic locations depicted on the second level geographic map displayed on the touchscreen display by touching the area of the touchscreen display displaying the second geographic location; and
recording the second geographic location in the first database.

2. The method of claim 1, further comprising the steps of:
displaying a keyboard on the touchscreen display for entering textual data into the database, and
recording textual data in the database by typing on the displayed keyboard.

3. The method of claim 1, wherein the first level geographic map is a world map depicting a plurality of countries.

4. The method of claim 1, wherein the first level geographic map is a world map depicting a plurality of countries including the United States, and the second database comprises a second level geographic map of the United States depicting a plurality of States.

5. A method of registration of information in a database, comprising the steps of:
providing a storage device for storing a database of information;
providing a display in communication with the storage device;
providing an input device for selecting an area of the display;
displaying a geographic map on the display, the geographic map depicting a plurality of geographic locations; and
recording one of the plurality of geographic locations in the database when the area of the display displaying the geographic location is selected by the input device.

6. The method of claim 5, wherein the display and the input device are combined in a touchscreen display.

7. The method of claim 6, further comprising the steps of:
displaying a keyboard on the touchscreen display for entering textual data into the database; and
recording textual data in the database by typing on the displayed keyboard.

8. The method of claim 5, wherein the storage device is in communication with the display through a computer network.

9. The method of claim 8, further comprising the steps of:
providing a computer connected to the computer network remotely from the input device; and
accessing the information recorded in the database using the computer.

10. The method of claim 9, further comprising the step of searching the information recorded in the database using the computer.

11. An apparatus for registration of information in a database, the apparatus comprising:
a storage device for storing a database;
a display for displaying a geographic map depicting a plurality of geographic locations, the display in communication with the storage device; and
an input device for selecting an area of the display;
wherein one of the plurality of geographic locations is recorded in the database when the area of the display displaying the geographic location is selected by the input device.

12. The apparatus of claim 11, wherein the display and the input device are combined in a touchscreen display.

13. The apparatus of claim 11, wherein the storage device is in communication with the display through a computer network.

14. The apparatus of claim 11, further comprising a computer connected to the computer network for accessing the information recorded in the database remotely from the input device.
